(19) United States
(12) Patent Application Publication
(10) Pub. No.: US 2010/0099067 A1
(43) Pub. Date: Apr. 22, 2010

(54) Mannequin for Medical Training

(76) Inventor: Felice Eugenio Agro', Rome (IT)

Correspondence Address: 24IP LAW GROUP USA, PLLC, 12 E. LAKE DRIVE, ANNAPOLIS, MD, 21403, US

(21) Appl. No.: 12/582,987

(22) Filed: Oct. 21, 2009

Related U.S. Application Data
(60) Provisional application No. 61/106,995, filed on Oct. 21, 2008.

(51) Int. Cl. G09B 23/28

(52) U.S. Cl. 434/272

(57) ABSTRACT

A mannequin representing a human body, anatomically particularized, adult aged and real sized with real motions. Special care is posed in selecting the materials in order to resemble the natural texture of human tissues. The aim of the mannequin is to allow the acquisition of medical skills in the field of pain management (peripheral anaesthesia techniques, vessels cannulation, port-a-cath implantation) through interchangeable modules simulating a plurality of anatomical variabilities (“drawers”).

### CROSS-REFERENCE TO RELATED APPLICATIONS

The present application claims the benefit of the filing date of U.S. Provisional Patent Application Ser. No. 61/106,995 filed by the present inventor on Oct. 21, 2008.

The aforementioned provisional patent application is hereby incorporated by reference in its entirety.

### STATEMENT REGARDING FEDERALLY SPONSORED RESEARCH OR DEVELOPMENT

None.

### BACKGROUND OF THE INVENTION

1. Field of the Invention

The present invention relates to the field of medical training for physicians and especially for anaesthesiologists. More specifically, this invention comprises a mannequin aimed for medical training. The mannequin allows users to simulate the practice of multiple medical actions, such as central and peripheral veins cannulation, nerve blocks, loco-regional anaesthesia, neurostimulator implantation and port-a-cath implantation.

2. Brief Description of the Related Art

In order to improve the field of sanitary training with the development of alternative methods which are not centered on patients, many research institutes are developing new human simulators. Further, many enterprises are offering new integrated simulation systems.

Various mannequins for medical training currently exist. For example, U.S. Pat. No. 5,823,787 discloses a training mannequin for management of normal and abnormal airways. Other examples include U.S. Pat. No. 7,284,986 entitled “Medical training aid having inflatable airways,” U.S. Pat. No. 5,314,339 entitled Educational Medical Mannequin,” U.S. Pat. No. 7,083,419 entitled “Doll for demonstrating a medical procedure” and U.S. Pat. No. 6,780,017 entitled “Cardiopulmonary resuscitation manikin with replaceable lung bag and installation tool.” None of the known mannequins, however, provides the chance to train different medical procedures or acts in a single simulator. Moreover, the existing mannequins do not adequately represent the human variability to adequately train physicians.

### SUMMARY OF THE INVENTION

The present invention is a mannequin representing a human body, anatomically particularized, adult aged and real sized with real motions. Special care is posed in selecting the materials in order to resemble the natural texture of human tissues.

The aim of the mannequin is to allow the acquisition of medical skills in the field of pain management (peripheral anaesthesia techniques, vessels cannulation, port-a-cath implantation) through interchangeable modules acting endless anatomical variabilities (“drawers”).

In a preferred embodiment, the present invention is a mannequin for medical training. The mannequin comprises a torso having a front and a back. The front and back each comprise a plurality of modules for simulating medical procedures. The torso further comprises narrowly particularized subclavear structures for simulating medical techniques. The mannequin further comprises two legs, two arms, a neck having carefully defined vessels and nerves to allow puncture and cannulation of a jugular vein, and a head. The legs, arms, neck and head move relative to the torso to realistically simulate movement of a human body. The mannequin further may have subclavear structures to simulate techniques of port-a-cath implantation, nerve blocks, and subclavear vein cannulation. Still further, the interchangeable modules may simulate physiologic, paraphysiologic and pathologic anatomical conditions.

The mannequin for simulating medical training may be sized to simulate an adult human, an adolescent human, a child human or an infant human. The materials used to construct the mannequin preferably resemble a natural texture of human tissue. Such materials used to construct the mannequin may for example, be polyvinyl chloride, thermoplastic elastomer, and thermoplastic polyurethane.

The torso back and/or front of the mannequin may comprise a plurality of interchangeable modules, for example, to simulate physiologic, paraphysiologic and pathologic anatomical conditions. One of the interchangeable modules of the torso back may comprise, for example, materials simulating tissues and structures of a dorso-lumbar region of a human body. Such tissues and structures of a dorso-lumbar region of a human body may comprise any or all of skin, subcutaneous fat, muscles, vertebrae, ligaments cartilages, vessels, a spinal cord and meningi. The vessels in the mannequin may be filled with artificial blood. Further, the mannequin for simulating medical training may have a structure or structures simulating a spinal cord and such structures may be filled with a transparent liquid to simulate cerebrospinal fluid.

The mannequin may further have a device connected to the nerves, wherein said device emits a sound when said nerves are punctured by a needle. Such device may be a simple or complex device that may have, for example, a microprocessor or an electronic circuit, a speaker, and wires.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIGS. 1(a) and (b) are side views of a preferred embodiment of a mannequin in accordance with a preferred embodiment of the present invention in a seated position.

FIG. 2 is a perspective view of a mannequin in accordance with a preferred embodiment of the present invention in a fetal position.

FIG. 3 is a side view of an upper portion of a mannequin in accordance with a preferred embodiment of the present invention to illustrate forward and rearward movement of the neck of the mannequin.

FIG. 4 is a front view of an upper portion of a mannequin in accordance with a preferred embodiment of the present inventions illustrating movement of an upper appendage of the mannequin.

FIG. 5 is a rear view of a mannequin in accordance with a preferred embodiment of the present in invention in a reclined position on its side.

FIG. 6 is a side view of a mannequin in accordance with a preferred embodiment of the present in invention in a reclined position on its back in a standing position.

FIG. 7 is a rear view of a mannequin in accordance with a preferred embodiment of the present invention in a standing position.

FIGS. 8(a) and (b) are front and side views of a mannequin in accordance with a preferred embodiment of the present invention in a standing position.

### DETAILED DESCRIPTION OF THE PREFERRED EMBODIMENTS

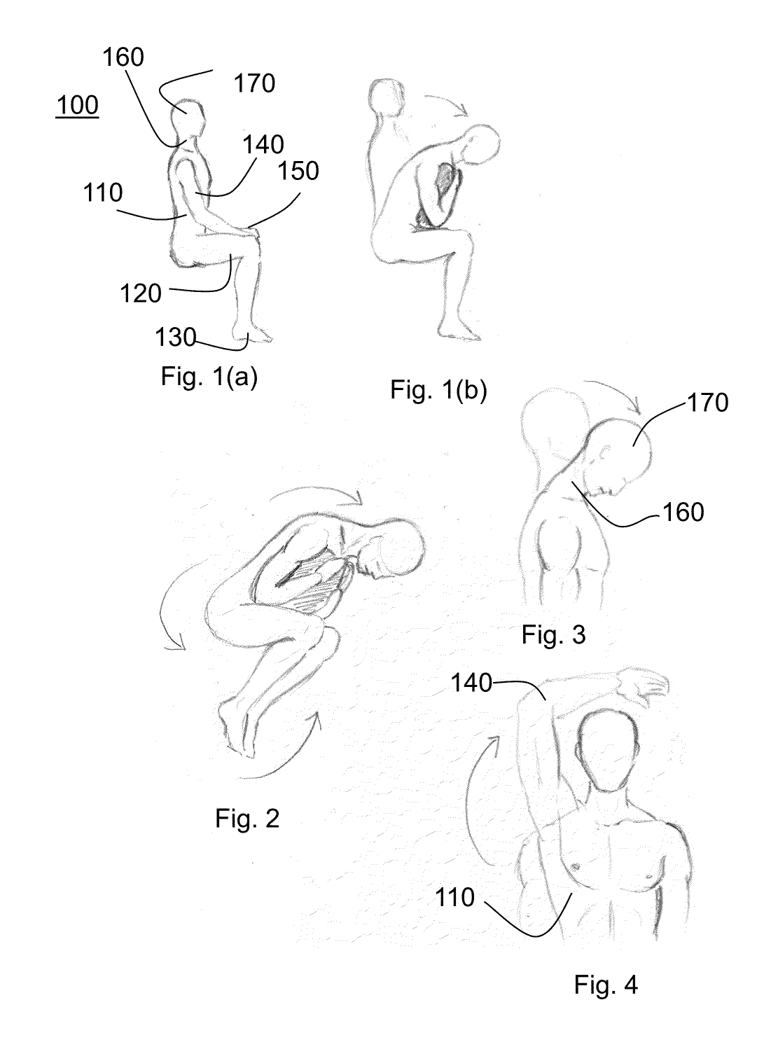

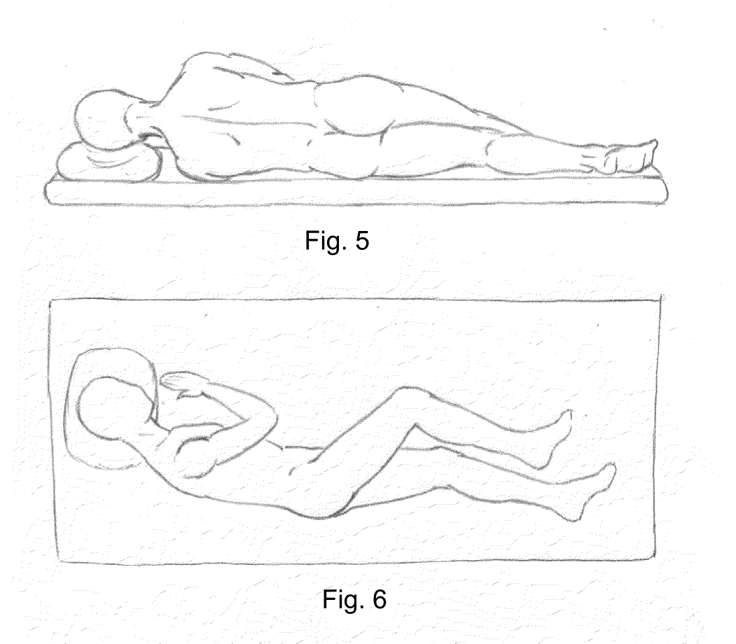

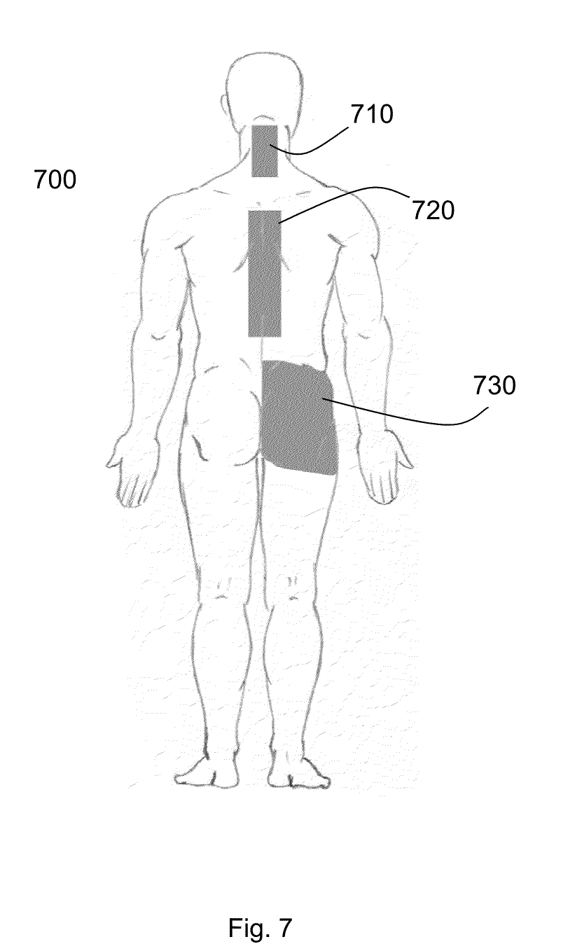

A preferred embodiment of the training mannequin of the present invention is described with reference to the drawings. The mannequin 100 represents a human body for purposes of training. The mannequin 100 is anatomically particularized with a torso 110, legs 120, fee 130, arms 140, hands 150, shoulders 160, neck 170 and head 180. In a preferred embodiment, the mannequin 100 is sized and proportioned to simulate an adult aged human. As shown in FIG. 1-4, the mannequin 100 real motions. FIGS. 1(a) and (b) illustrate the mannequin's realistic torso movement. FIG. 2 illustrates the mannequin's realistic movement into and out of a fetal position. FIG. 3 illustrates the mannequin's realistic movement of the head 170 and neck 160. FIG. 4 illustrates the mannequin's realistic movement of an upper appendage or arm 140 and hand 150. FIGS. 5 and 6 illustrate the mannequin placed into a reclined position to simulate a patient. The aim of the mannequin is to allow the acquisition of medical skills in the field of pain management (peripheral anaesthesia techniques, vessels cannulation, port-a-cath implantation) through interchangeable modules acting endless anatomical variabilities (“drawers”).

In a preferred embodiment, special care is posed in selecting the materials used to construct the mannequin in order to resemble the natural texture of human tissues. The vessels and the nerves of the neck are carefully defined in order to allow puncture and cannulation of the jugular vein. Subclavear structures are narrowly particularized so that the feasible simulation of techniques such as port-a-cath implantation, nerve blocks, subclavear vein cannulation, etc.

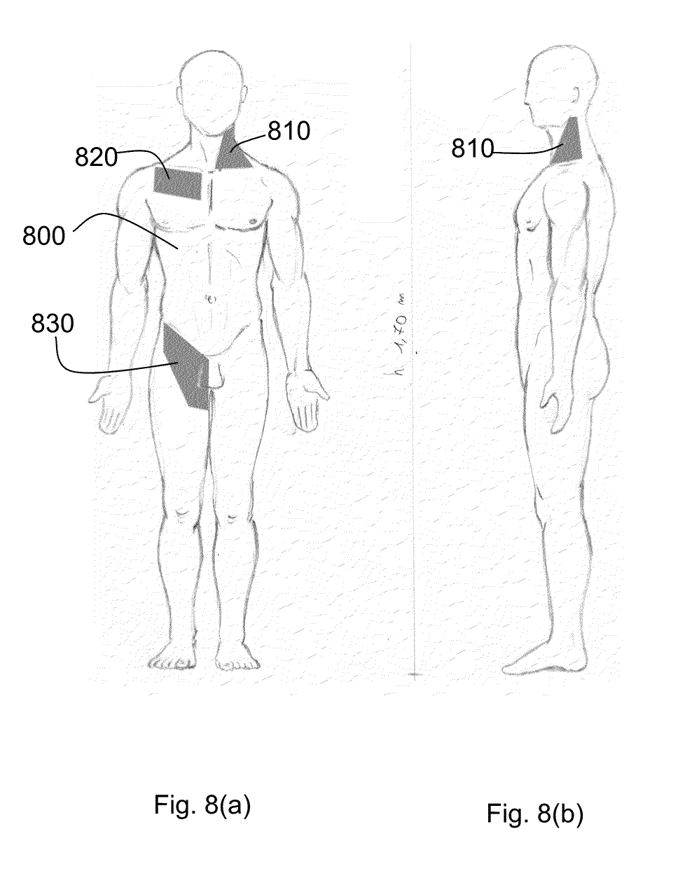

As shown in FIG. 7, the mannequin's back 700 comprises interchangeable modules 710, 720, 730 that simulate physiologic, paraphysiologic and pathologic anatomical conditions. In each module there are all the tissues and the structures which constitute the dorso-lumbar region: skin, subcutaneous fat, muscles, vertebrae, ligaments, cartilages, vessels, spinal cord, and meningi. Similarly, as shown in FIG. 8, the mannequin's front 800 comprises interchangeable modules 810, 820, 830.

In a preferred embodiment, anatomic structures in the mannequin were closely reconstructed by Volume Rendering TC images (“TC-VR”). The TC-VR images were acquired the structures were produced by a tridimensional stamp in STL format. In this way, the preferred embodiment was able to include all the tissues and structures which constitute human body: skin, subcutaneous fat, muscles, vertebrae, ligaments, nerves, cartilages, vessels, spinal cord, meningi.

The mannequin of a preferred embodiment is 170 cm tall and 50 cm wide at shoulders-level. The trunk or torso is 55 cm long. The upper limbs or arms each are 65 cm long. The lower limbs or legs each are 95 cm long. The vessels are filled with artificial blood. The nerves in the preferred embodiment are connected to a device which emits a sound when they are punctured by a needle.

The tissues of the mannequin or simulator are made of different materials: polymers as the Polyvinyl Chloride (PVC), Thermoplastic Elastomer (TPE), Thermoplastic Polyurethane (TPU) or silicone elastomers as the Polydimethylsiloxane (PDMS). The vessels are filled with artificial blood. The cerebrospinal fluid is represented by means of transparent liquid. The nerves are connected to a device which emits a sound when they are punctured by a needle. The limbs are designed to practice venous and arterial puncture and peripheral nerve blocks.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A mannequin for medical training comprising:
a torso having a front and a back, said front and back each comprising a plurality of modules for simulating a plurality of medical procedures, said torso further comprising narrowly particularized subclavear structures for simulating medical techniques;
two legs;
two arms;
a neck having carefully defined vessels and nerves to allow puncture and cannulation of a jugular vein; and
a head;
wherein said legs, arms, neck and head move relative to said torso to realistically simulate movement of a human body.

2. A mannequin for simulating medical training according to claim 1, wherein said subclavear structures simulate techniques of port-a-cath implantation, nerve blocks, and subclavear vein cannulation.

3. A mannequin for simulating medical training according to claim 1, wherein said interchangeable modules simulate physiologic, paraphysiologic and pathologic anatomical conditions.

4. A mannequin for simulating medical training according to claim 1 wherein said mannequin is sized to simulate an adult human.

5. A mannequin for simulating medical training according to claim 1 wherein materials used to construct said mannequin resemble a natural texture of human tissue.

6. A mannequin for simulating medical training according to claim 5 wherein materials used to construct said mannequin comprise at least one of polyvinyl chloride, thermoplastic elastomer, and thermoplastic polyurethane.

7. A mannequin for simulating medical training according to claim 1 wherein said torso back comprises a plurality of interchangeable modules.

8. A mannequin for simulating medical training according to claim 7 wherein said interchangeable modules of said torso back simulate physiologic, paraphysiologic and pathologic anatomical conditions.

9. A mannequin for simulating medical training according to claim 7 wherein one of said interchangeable modules of said torso back comprises materials simulating tissues and structures of a dorso-lumbar region of a human body.

10. A mannequin for simulating medical training according to claim 9 wherein said tissues and structures of a dorso-lumbar region of a human body comprise skin, subcutaneous fat, muscles, vertebrae, ligaments cartilages, vessels, a spinal cord and meningi.

11. A mannequin for simulating medical training according to claim 1 wherein said torso front comprises a plurality of interchangeable modules.

12. A mannequin for simulating medical training according to claim 1 wherein said vessels are filled with artificial blood.

13. A mannequin for simulating medical training according to claim 1 wherein said torso comprises structure simulating a spinal cord.

14. A mannequin for simulating medical training according to claim 13 wherein said structure simulating a spinal cord is filled with a transparent liquid to simulate cerebrospinal fluid.

15. A mannequin for simulating medical training according to claim 1 further comprising a device connected to said nerves, wherein said device emits a sound when said nerves are punctured by a needle.
